(19) United States
(12) Patent Application Publication
(10) Pub. No.: US 2020/0314530 A1
(43) Pub. Date: Oct. 1, 2020

(54) Earphone Having Wiring Elasticity and Wearing Method

(71) Applicant: Asahi Kasei Kabushiki Kaisha, Tokyo (JP)

(72) Inventors: Weiming Chu, Tokyo (JP); Shunji Tatsumi, Tokyo (JP)

(73) Assignee: Asahi Kasei Kabushiki Kaisha, Tokyo (JP)

(21) Appl. No.: 16/307,205

(22) PCT Filed: Jun. 12, 2017
(86) PCT No.: PCT/JP2017/021677

§ 371 Date: Dec. 5, 2018

(30) Foreign Application Priority Data
Jun. 13, 2016 (JP) 2016-117295

(51) Int. Cl. H04R 1/10

(52) U.S. Cl. CPC H04R 1/1091; H04R 2420/07; H04R 1/1033

(57) ABSTRACT

The present invention provides an earphone that reduces a contact sound generated when, for example, one moves while wearing the earphone or generated upon contact of a wiring or a substrate (component) with clothing or the human body and a frictional sound when the clothing or the skin of the human body rubs against the wiring or the substrate (component), and suppresses an unpleasant sound that would otherwise be heard from these sounds through the wiring. The earphone is provided with a pair of left and right speakers and a circuit to drive the speakers, and further provided with at least one substrate having a circuit including a communication circuit and/or a cell and a wiring for connecting the left and right speakers together or a wiring for connecting the left and right speakers separately to the substrate, the wiring having elasticity.

### FIELD

The present invention relates to earphones for music appreciation and audio playback and a method for equipping the same.

### BACKGROUND

Conventionally, the wires used for earphones for music appreciation and audio playback are not elastic. Earphones having long wires or earphones in which the wires can be internally housed, whereby the earphones can be worn by wearers of different ages and head sizes have become popular. However, since inelastic wires are used, it takes time to reliably arrange the earphones in the ears. In order to eliminate unpleasant feelings, such as the sagging of wires, in recent years, earphones provided with wire winding devices whereby the wires can be internally housed have been proposed (for example, Patent Literature 1).

In conventional earphones, the wires lack elasticity and thus the wires sag. Consequently, when exercising, shaking of the wires occurs. Due to the effect of the shaking, impact noise, which is generated when the wires or the substrate (component) impact clothes or the body, and fricatives, which are generated when the wires or substrate (component) rub against clothes or the body, are generated. These sounds pass through the wires and are heard, whereby music cannot be heard or audio cannot be played back comfortably. Further, due to slack in the wires, the wires can become caught on clothing or surrounding objects, whereby the earphones are pulled, and can be drawn from the ear canals. Furthermore, when equipping earphones, it is considered preferable to place the wires over clothes or the like so as not to touch the skin. Because there is slack in the wires, when the wearer exercises after equipping the earphones, the shaking of the wires causes the wires to become displaced from their initial proper place, and the wires often touch the skin, causing discomfort. Thus, it is necessary to again adjust the position of placement of the wires and the time required to equip the earphones increases.

In the configuration of Patent Literature 1, the wires can be shortened to some extent by winding the wires, but some sort of equipment is necessary for the winding of the wires. In many cases, the equipment is large and heavy. When exercising, shaking of the equipment for winding the wires and discomfort due to contact with the head occur. Further, the impact noise generated when contact is made with the head can be heard through the wires, and high-quality music and sound reproduction cannot be realized.

Though completely wireless earphones, in which each earpiece is completely separate, have been released, there is a problem that it is necessary to install a battery and a communication module in each of the left and right earpieces, and the earpieces are large and heavy. Further, there is also a problem that since the earpieces are individually separated, they can be easily lost.

### CITATION LIST

### Patent Literature

[PTL 1] Japanese Utility Model Registration No. 3183367

### SUMMARY

### Technical Problem

The present invention has been achieved in view of such conventional circumstances. The present invention aims to provide earphones in which impact noise, which is generated when the wires or the substrate (component) impact clothes or the body, and fricatives, which are generated when the wires or substrate (component) rub against clothes or the body, are reduced and in which such sounds cannot be heard through the wires. Further, the present invention aims to provide earphones in which the wires do not sag or become caught on clothing or surrounding objects when worn and the earphones are not pulled, whereby the earphones tend not to be drawn from the ear canals, and in a significant amount of time is not required to equip the earphones.

In the earphones of Patent Literature 1, the wires can be shortened to some extent by winding the wires, but some sort of equipment is necessary for the winding of the wires. Furthermore, the size of the equipment is large and often feels heavy. When exercising, shaking of the equipment for winding the wires and discomfort due to contact with the head occur.

Further, the impact noise generated when contact is made with the head can be heard through the wires, and high-quality music and sound reproduction cannot be realized.

### Solution to Problem

The inventors of the present invention have discovered, as a result of intensive experimentation in order to solve the above-mentioned problems, that by imparting elasticity to the wires of the earphones, even when exercising while wearing the earphones, the wires and substrate (component) are less likely to impact with or rub against clothing or the body, whereby the occurrence of unpleasant sounds generated thereby which are heard via wires, such as impact noise and fricatives, can be reduced. Further, the inventors of the present invention have determined that if the wires have elasticity, when worn, the wires do not sag and do not become caught on clothing or surrounding objects, and thus, the earphones tend not to be pulled and drawn from the ear canals, whereby the time required to reliably equip the earphones is not increased, leading to the achievement of the present invention.

In other words, the present invention is as described below.
[1]
Earphones comprising:
a pair of left and right speakers,
at least one substrate including a circuit having a wireless communication circuit in addition to a circuit for driving the speakers and/or a battery, and
wires connecting the left and right speakers or wires individually connecting the left and right speakers and the substrate, wherein
the wires have elasticity.
[2]
The earphones according to [1], wherein
the pair of left and right speakers are a left-side speaker and a right-side speaker,
the left-side speaker and the substrate are connected by a first wire,
the right-side speaker and the substrate are connected by a second wire, and
the first and second wire have elasticity.
[3]
The earphones according to [1], wherein
the substrate includes a left-side substrate and a right-side substrate,
the left-side speaker and the left-side substrate are connected by a first wire,
the right-side speaker and the right-side substrate are connected by a second wire,
the left-side substrate and the right-side substrate are connected by a third wire, and
the first wire and the second wire have elasticity.
[4]
The earphones according to [1], wherein the substrate is housed in the left-side speaker or the right-side speaker, and
the left-side speaker and the right-side speaker are connected by a wire having elasticity.
[5]
The earphones according to any one of [1] to [4], wherein
the wires have an elasticity of at least 10%, and the stress when the wires which have been elongated by at least 10%, self-contract to a length which is 110% the length at the time of no elongation is not greater than 2N.
[6]
The earphones according to any one of [1] to [5], wherein there are at least three wiring lengths depending on the distance between a left-side end of the left-side speaker and a right-side end of the right-side speaker.
[7]
The earphones according to any one of [1] to [6], wherein the substrate or the speakers include a mechanism that can adjust the wiring length.
[8]
The earphones according to [6] or [7], wherein the wiring length can be adjusted by winding the wires on the substrate or the speakers or by meanderingly arranging the wires.
[9]
The earphones according to any one of [6] to [8], wherein the substrate is provided with at least six protruding parts through which the wires pass, the wiring length is adjusted depending on the number of protruding parts through which the wires pass, and the wires include a mechanism for attachment to the protruding parts.
[10]
The earphones according to any one of [6] to [9], wherein the wiring length can be adjusted by changing the number of times the wires are wound around the left-side speaker and the right-side speaker, and the wires include a mechanism for attachment to clearances provided in both speakers.
[11]
The earphones according to any one of [6] to [10], wherein when the earphones are worn on a head, the wiring length can be adjusted so that a pressure applied to the head by the substrate is 0.1 hpa to 30 hpa.
[12]
A method for equipping the earphones according to any one of [1] to [11], wherein when the earphones are worn on a head, a pressure applied to the head by the substrate is 0.1 hpa to 30 hpa.
[13]
A method for equipping the earphones according to any one of [1] to [11], wherein the wires are attached in groove parts between the left and right ears and the head.
[14]
A method for equipping the earphones according to any one of [1] to [11], wherein there is no shaking of the substrate, components or wires, so that impact noise and fricatives are reduced in heard sounds.
[15]
A method for equipping the earphones according to any one of [1] to [11], wherein by attaching the substrate and components to the occipital region or top of the head with contraction force of the wires, even if a wearer moves or moves their head, the substrate and components do not move.

### Advantageous Effects of Invention

In the first aspect of the present invention, provided are, for example, earphones comprising a left-side speaker to be worn in the left ear and a right-side speaker to be worn in the right ear, wherein a substrate (component) including a circuit for driving the speakers, another circuit, and a battery is provided between the speakers, and the substrate is connected to each of the speakers by elastic wires.

In the second aspect of the present invention, provided are earphones comprising a left-side speaker to be worn in the left ear and a right-side speaker to be worn in the right ear, wherein two substrates (components) each including a circuit for driving the speakers, another circuit, and a battery are provided between the corresponding speakers, the wires between the two substrates (components) are elastic wires or inelastic wires, and the substrates (components) are connected to the respective speakers by elastic wires.

In the third aspect of the present invention, provided are earphones comprising a left-side speaker to be worn in the left ear and a right-side speaker to be worn in the right ear, wherein the substrate (component) including a circuit for driving the speakers, another circuit, and a battery is housed within the same component as the left-side speaker or the right-side speaker, and the speakers are connected by elastic wires.

In the earphone equipping method of the present invention, the substrate (component), etc., is arranged at the back of the head or near the top of the head, the wires are arranged along the grooves between the ears and the head (between the helix and the fossa), and the speakers are inserted into the ear canals, whereby the substrate (component) is stabilized behind the head or near the top of the head. Namely, after attaching the earphones with the extended wires, the substrate (component) can be stabilized behind the head or near the top of the head with the contraction force of the wires. Thus, even if the wearer moves or moves their head, it is unlikely that the substrate (component) will move. When the substrate (component) is stabilized behind the head or near the top of the head, a mechanism by which the length of the wires can be adjusted wherein the wires are extended so that the pressure of the contraction force exerted on the head by the substrate (component) does not impart discomfort to the wearer is provided. Furthermore, since the length of wires can be adjusted, the earphones can fit the head sizes of many different wearers.

When the earphones having elastic wires as described above are worn by such a method, not only can the earphones be quickly equipped, but also the substrate (component) can be stabilized by the elasticity of wires whereby shaking of the wires and issues related to the wires can be minimized during exercise, and impact noise and fricatives generated due to the shaking of the wires can be minimized.

Note that the above summary of the invention does not limit the features of the present invention. Furthermore, sub-combinations of these feature groups may also be made.

### BRIEF DESCRIPTION OF DRAWINGS

FIG. 1 is a view showing a configuration example of Patent Literature 1.

FIG. 2A is a view showing the configuration of the first aspect (Example 1).

FIG. 2B is a view showing the configuration of the second aspect (Example 2).

FIG. 2C is a view showing the configuration of the third aspect (Example 3).

FIG. 3A is a view showing a first example of the elastic characteristics of the retractable wiring.

FIG. 3B is a view showing a second example of the elastic characteristics of the retractable wiring.

FIG. 4A is a view showing a first example of adjusting the length of the retractable wiring of the substrate (component).

FIG. 4B is a view showing a second example of adjusting the length of the retractable wiring of the speaker.

FIG. 5A is a side view showing a method for equipping the earphones of the present invention.

FIG. 5B is a rear view showing a method for equipping the earphones of the present invention.

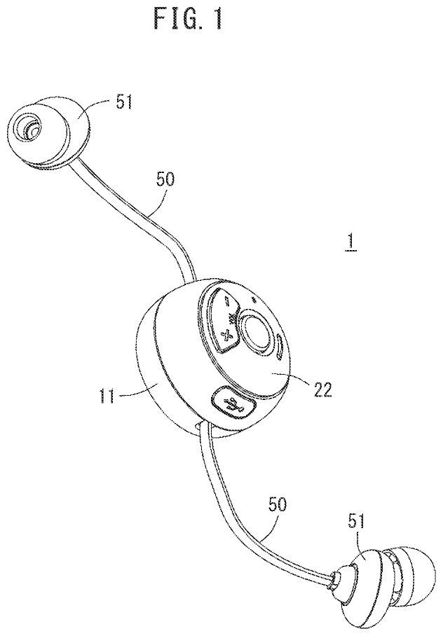

### DESCRIPTION OF EMBODIMENTS

The embodiments of the present invention will be explained below. However, the following embodiments do not limit the inventions according to the claims. Furthermore, not all combinations of the features described in the embodiments are necessarily indispensable to the solving means of the invention.

### EXAMPLES

### Example 1

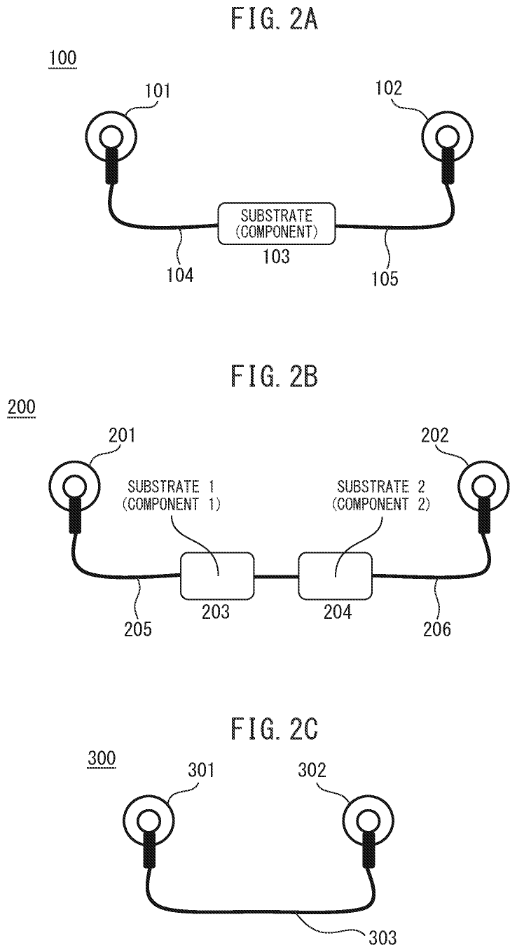

FIG. 2A shows an overview of the configuration 100 of the first aspect (Example 1). The configuration 100 of the present example includes a left-side speaker 101, a right-side speaker 102, a substrate (component) 103, a first elastic wire (1) 104 and a second elastic wire (2) 105.

The left-side speaker 101 is a component to be worn in the left-side ear and which reproduces music, voice, etc. The right-side speaker 102 is a component to be worn in the right-side ear and which reproduces music, voice, etc. The substrate (component) 103 is provided between the left-side speaker 101 and the right-side speaker 102. The substrate (component) 103 includes a circuit for driving the left-side speaker 101 and the right-side speaker 102, another circuit, a battery, etc. The substrate (component) 103 may include a wireless communication circuit.

The substrate (component) 103 and the left-side speaker 101 are connected by the elastic wire (1) 104. The substrate (component) 103 and the right-side speaker 102 are connected by the elastic wire (2) 105. The elastic wire (1) 104 and the elastic wire (2) 105 are elastic, and preferably have a maximum elongation rate of 5% to 300%, particularly preferably 10% to 200%.

Maximum elongation rate (%)=(the length of the wire at the time of maximum elongation/the length of the wire when not elongated−1)×100

Example of the method for measuring the maximum elongation rate:
Step 1) Cut 20 cm of unelongated wire.
Step 2) Holding the wire vertically, fix one point at one side end and make a mark at a point 10 cm away from the fixed point.
Step 3) Apply a load of 500 g to the other side and measure the distance between the fixed point and the aforementioned mark.
Step 4) The rate of elongation=[(the distance obtained in Step 3/10 cm)−1]×100

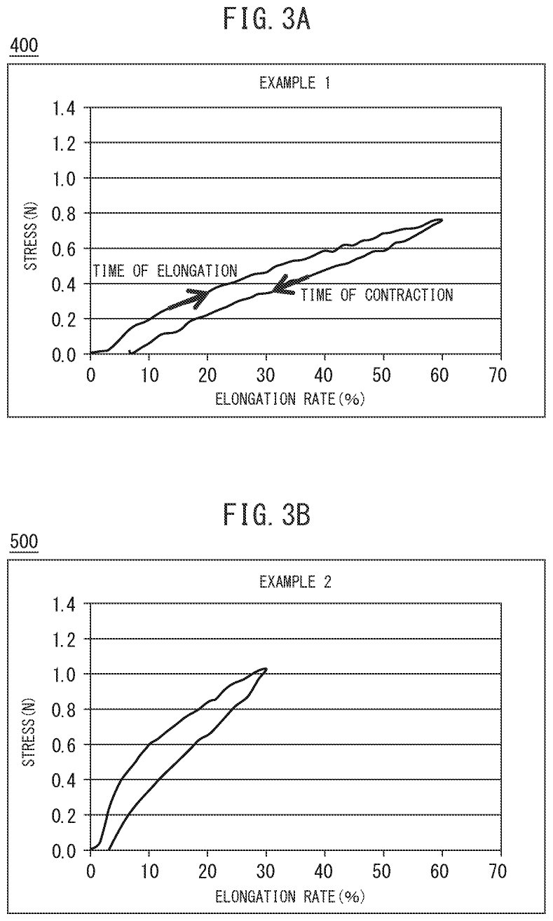

When earphones using the first elastic wires (1) 104 and the second elastic wires (2) 105 are worn on the head, after the wires have been extended and the earphones have been equipped, the earphones are fixed to the head with the contract force of the wires. FIG. 3A shows a first example 400 of the elastic characteristics of weakly elastic wires and FIG. 3B shows a second example 500 of the elastic characteristics of semi-strongly elastic wires. The stress when the wires, which have been elongated by 10% or more, self-contract to a length which is 110% the length at the time of no elongation is approximately 0.07 N for the weakly elastic wires shown in FIG. 3A and approximately 0.3 N for the semi-strongly elastic wires shown in FIG. 3B. The stress when the wires, which have been elongated by at least 10%, self-contract to a length which is 110% the length at the time of no elongation is preferably 2 N or less, particularly preferably 1 Nor less.

When music, voice, etc., is reproduced, the substrate (component) 103 receives a radio signal from a device such as a smartphone, converts the received signal into a voice signal, and transmits the voice signal to the left-side speaker 101 and the right-side speaker 102 by the speaker drive circuit. The first elastic wire (1) 104 transmits the necessary audio signals and control signals to the left-side speaker 101. The second elastic wire (2) 105 transmits the necessary audio signals and control signals to the right-side speaker 102.

Regarding the earphones of the first aspect (Example 1) 100, the wires are elastic. When the wires, which have been slightly elongated, are equipped, the substrate (component) 103 and the wires can be stabilized (fixed) with the contraction force of the wires, whereby the component and the wires are so-called “stabilized”. Thus, even if the wearer moves or moves his or her head, it is unlikely that the component or the wires will move, whereby not only can impact noise and fricatives due to shaking of the wires be reduced, but also the impact noise and fricatives themselves generated by the substrate (component) can be reduced. In the earphones of Patent Literature 1, though the wires can be stored, since the wires lack elasticity, it is difficult to stabilize the substrate and winding equipment, whereby impact noise and fricatives will be generated by the substrate and winding equipment during exercise. Thus, it is difficult to realize high-quality music and sound reproduction.

When the earphones are worn on the head, in order to stabilize (fix) the substrate (component) on the head, i.e., in order to realize so-called “stabilization”, the pressure exerted by the substrate (component) on the head is preferably 0.1 hpa to 30 hpa. If the pressure exerted on the head is less than 0.1 hpa, the substrate (component) will not contact the head closely, and there is a risk that shaking of the wires will occur due to exercise or the like, whereby impact noise and fricatives will be generated due to the shaking of the wires. If the pressure is greater than 30 hpa, the substrate will be fixed to the head at a significant pressure and the wires exert a strong pressure on the head, whereby discomfort is felt by the wearer, and high-quality music and sound reproduction cannot be realized. The pressure exerted is more preferably 2 hpa to 10 hpa. The wires can be elongated by more than 10%, and the stress when the wires after elongation self-contract to a length which is 110% the length at the time of no elongation is 1 N or less. A mechanism is provided for adjusting the wiring length in the range of 100 to 150% of the length at the time of no elongation.

### Example 2

FIG. 2B shows an overview of the configuration 200 of the second aspect (Example 2). The configuration 200 of the present example includes a left-side speaker 201, a right-side speaker 202, a left-side substrate (component 1) 203, a right-side substrate (component 2) 204, a first elastic wire (1) 205, and a second elastic wire (2) 206.

The left-side speaker 201 is a component to be worn in the left-side ear and which reproduces music, voice, etc. The right-side speaker 202 is a component to be worn in the right-side ear and which reproduces music, voice, etc. The left-side substrate (component 1) 203 and the right-side substrate (component 2) 204 are provided between the left-side speaker 201 and the right-side speaker 202. The left-side substrate (component 1) 203 includes a circuit for driving the left-side speaker 201 and another circuit or a battery, etc. The right-side substrate (component 2) 204 includes a circuit for driving the right-side speaker 202, and another circuit or a battery, etc. The substrate (component) 203 or 204 may include a wireless communication circuit.

The left-side substrate (component 1) 203 and the left-side speaker 201 are connected by the first elastic wire (1) 205. The right side-substrate (component 2) 204 and the right-side speaker 202 are connected by the second elastic wire (2) 206. The first elastic wire (1) 205 and the second elastic wire (2) 206 are elastic and preferably have an elongation rate of 5% to 300%, particularly preferably 10% to 200%. The left-side substrate (component 1) 203 and the right-side substrate (component 2) 204 are connected by an inelastic wire or elastic wire. The stress when the wires, which have been elongated by at least 10%, self-contract to a length which is 110% the length at the time of no elongation is preferably 2 N or less, particularly preferably 1 N or less.

When music, voice, etc., is reproduced, the left-side substrate (component 1) 203 or the right-side substrate (component 2) 204 receives a radio signal from a device such as a smartphone, converts the received signal into a voice signal, and transmits the voice signal, by the drive circuit, from the left-side substrate (component 1) 203 to the left-side speaker 201 and from the right-side substrate (component 2) 204 to the right-side speaker 202. The first elastic wire (1) 205 transmits the necessary audio signals and control signals to the left-side speaker 201. The second elastic wire (2) 206 transmits the necessary audio signals and control signals to the right-side speaker 202.

Regarding the earphones of the second aspect (Example 2) 200, the wires are elastic. When the earphones are worn in a state in which the wires are slightly elongated, similar to the first aspect, the substrate (component) can be “stabilized” (fixed) with the contraction force of the wires, whereby not only can impact noise and fricatives due to shaking of the wires be reduced, but also the impact noise and fricatives generated by the substrate (component) can be reduced. In the earphones described in Patent Literature 1, though the wires can be stored, since the wires lack elasticity, there is no force to “stabilize” the winding equipment, whereby impact noise and fricatives will still be generated by the substrate and winding equipment during exercise. Thus, it is difficult to realize high-quality music and sound reproduction. As in the first aspect (Example 1) 100, when the earphones are worn, the pressure exerted on the head by the substrate (component) is preferably 0.1 hpa to 30 hpa, particularly preferably 2 hpa to 10 hpa.

### Example 3

FIG. 2C shows an overview of the configuration 300 of the third aspect (Example 3). The configuration 300 of the present example includes a left-side speaker 301, a right-side speaker 302, and an elastic wire 303.

The left-side speaker 301 is a component to be worn in the left-side ear, includes a circuit for driving the speaker, and reproduces music, voice, etc. The right-side speaker 302 is a component to be worn in the right-side ear, includes a circuit for driving the speaker, and reproduces music, voice, etc. The substrate (component), which includes a wireless communication circuit, another circuit, or a battery, is housed in the left-side speaker 301 or the right-side speaker 302.

The left-side speaker 301 and the right-side speaker 302 are connected by an elastic wire 303. The elastic wire 303 is elastic, and preferably has an elongation rate of 5% to 300%, particularly preferably 10% to 200%. Furthermore, the stress when the wire, which has been elongated by at least 10%, self-contracts to a length which is 110% the length at the time of no elongation is preferably 2 N or less, particularly preferably 1 N or less.

When music, voice, etc., is reproduced, the left-side speaker 301 or the right-side speaker 302 receives a wireless signal from a communication device such as a smartphone, converts the received signal into a voice signal, and transmits the voice signal to the left-side speaker 301 or the right-side speaker 302 by the drive circuit. The elastic wire 303 transmits the necessary voice signals and control signals to the left-side speaker 301 or transmit the necessary voice signals and control signals to the right-side speaker 302.

Regarding the earphones of the third aspect (Example 3) 300, the wire is elastic. Thus, when the earphones are worn in a state in which the wire is slightly elongated, similar to the first aspect and the second aspect, the wire can be brought into close contact with the head, whereby the impact noise and fricatives generated by the wire can be reduced.

As described above, in the earphones of the present example, which are composed of elastic wires, the wires do not sag and when exercising, there is no shaking of the wires, whereby impact noise, which is generated when the wires impact clothes or the body, and fricatives, which are generated when the wires rub against clothes or the body, can be eliminated, and high-quality music and sound reproduction can be realized. Furthermore, there is no risk that the wires will become caught on clothes or surrounding objects due to slack in the wires, whereby the earphones are pulled and drawn from the ear canals. Further, equipment for winding the wires becomes unnecessary, whereby the substrate (component) can be made small and lighter. Moreover, due to the contraction force of the elastic wires, discomfort when substrate (component) comes into contact with head when moving and impact noise and fricatives generated when the substrate impacts the head can be reduced, whereby comfortable high-quality music and sound reproduction can be realized.

The earphones of the present invention can be adjusted to the size of the heads of various wearers or the substrate (component) can be stabilized on the back or top of the head by the optimal contraction force of the wires. Since the pressure imparted by the substrate (component) does not cause discomfort to the wearer, the embodiments 1, 2, and 3 of the present invention also provide a mechanism by which adjustment of the wiring length is possible.

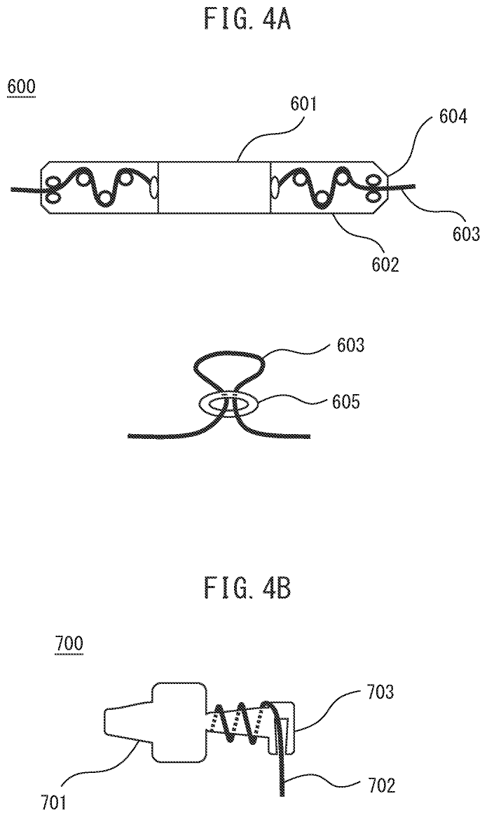

FIG. 4A is a view showing an example (1) 600 of adjusting the length of the retractable wiring of the substrate (component). FIG. 4A shows the mechanism by which the wiring length can be adjusted included in the substrate (component). A plurality of protruding parts 602 are provided in the substrate (component) 601 in an alternatingly arranged manner. The retractable wiring 603 is not arranged in a straight manner. However, the retractable wiring 603 can be made longer than a straight arrangement by spanning the protruding parts while meanderingly arranging the wire. Furthermore, the wire can be fixed by passing the wire through the last two protruding parts 604 for attachment of the wire. The wiring length can be adjusted depending on the number of protruding parts 602 spanned by the wire. In consideration of bilateral symmetry, it is preferable to have three or more protruding parts on each of the left side and the right side of the substrate (component) (a total of six or more). It is possible to adjust the wiring length in the same manner by providing a plurality of grooves instead of the above protruding parts and spanning the grooves while meanderingly arranging the wire. The number of grooves is preferably at least 3 on each of the left side and the right side of the substrate (component) (a total of six or more). The wire 603 passes through a wire-securing ring-like component 605 which fixes the wire by pinching the wire, and the length of the wire can also be adjusted by changing the wiring length passing through the ring-like component 605. The mechanism whereby the wiring length can be adjusted can have three or more different wiring lengths depending on the distance between the left-side end of the left-side speaker and the right-side end of the right-side speaker.

FIG. 4B is an example (2) 700 of adjusting the length of the retractable wiring of the speaker. FIG. 4B shows the mechanism by which the wiring length can be adjusted included in the speaker. The retractable wire 702 can be wound around the speaker body 701 and the wiring length can be adjusted by changing the number of windings. Furthermore, attachment clearance 703 for attaching the wire is provided in the speaker. By passing the wire through the clearance, the wound wire can be securely attached. The mechanism by which the wiring length can be adjusted can have three or more different wiring lengths depending on the distance between the left-side end of the left-side speaker and the right-side end of the right-side speaker.

Although the present invention has been described with reference to the embodiments, the technical scope of the present invention is not limited to the scope described in the above embodiments. It will be apparent to a person skilled in the art that various modifications or improvements can be made to the above embodiments. It is obvious from the description of the scope of the claims that embodiments including such modifications or improvements are included in the technical scope of the present invention.

The method for equipping the earphones according to the invention will be explained below, though the equipping method does not limit the methods according to the claims. Furthermore, not all combinations of the methods described in the equipping methods are necessarily indispensable to the solving means of the present invention.

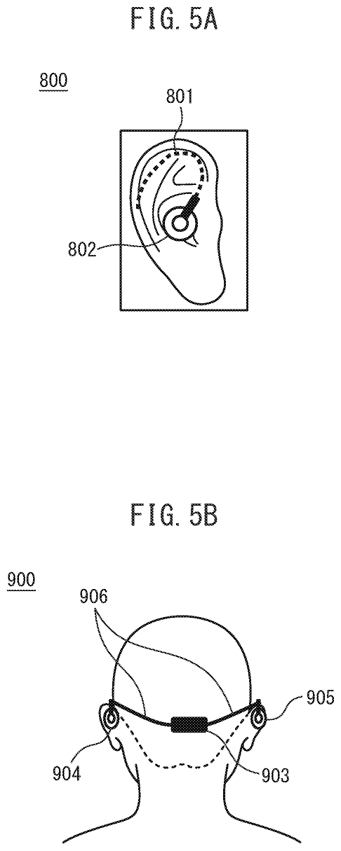

FIG. 5A is a view showing the earphone equipping method (1) 800. FIG. 5A is a side-view showing the earphones after having been equipped. The speaker 802 is arranged in the ear canal and the elastic wire 801 is placed in the groove between the helix and the fossa. This wire connects the speaker and the substrate (component) or connects the left and right speakers, and transmits a signal or power to the speaker(s). The above side view after the earphones have been equipped can correspond to both the left ear and the right ear.

FIG. 5B is a view showing the earphone equipping method (2) 900. FIG. 5B shows a view 900 in which the earphones having the configuration of the first aspect (Example 1) have been equipped as viewed from the back of the head. The substrate (component) 903 is placed on the back of the head, the left-side speaker 904 is inserted into the left ear, and the right-side speaker 905 is inserted into the right ear. The left-side speaker 904 and the substrate (component) 903, and the right-side speaker 905 and the substrate (component) 903 are each connected via elastic wires 906. These wires are placed in the grooves between the earlobe of the left ear or the right ear and the fossa.

A method for quickly equipping the earphones having the configuration of the first aspect (Example 1) includes the following steps:

Step 1) Arrange the substrate (component) 903 of the earphones on the back of the head or the top of the head.
Step 2) While holding both speakers, arrange the elastic wires along the grooves between the ears and the head from the back of the head or near the top of the head to the front of the head.
Step 3) Insert the speakers into the ear canals.

As described above, by using the equipping method of the earphones structure of the present example composed of elastic wires, it is possible to equip the earphones quickly and it is possible to eliminate the feeling of frustration associated with the inability to easily and quickly equip the earphones.

### REFERENCE SIGNS LIST

1 wireless earphones
11 lower lid
22 upper lid
50 earphone cord
51 speaker part
100 first aspect
101 left-side speaker
102 right-side speaker
103 substrate
104 elastic wire (1)
105 elastic wire (2)
200 second aspect
201 left-side speaker
202 right-side speaker
203 substrate 1
204 substrate 2
205 elastic wire (1)
206 elastic wire (2)
300 third aspect
301 left-side speaker
302 right-side speaker
303 elastic wire
400 example of elastic characteristics of elastic wire (1)
500 example of elastic characteristics of elastic wire (2)
600 example of adjusting length of retractable wiring of substrate (component) (1)
601 substrate
602 protruding parts
603 retractable wiring
604 protruding parts for attachment of wiring
605 ring-like wiring attachment component
700 example of adjusting length of retractable wiring of speaker (2)
701 speaker body
702 retractable wiring
703 clearance for attachment of wiring
800 earphone equipping method (1)
801 elastic wire
802 speaker
900 earphone equipping method (2)
903 substrate
904 left-side speaker
905 right-side speaker
906 elastic wire

1. Earphones comprising:
a pair of left and right speakers,
at least one substrate including a circuit having a wireless communication circuit in addition to a circuit for driving the speakers and/or a battery, and
wires connecting the left and right speakers or wires individually connecting the left and right speakers and the substrate, wherein
the wires have elasticity.

2. The earphones according to claim 1, wherein
the pair of left and right speakers are a left-side speaker and a right-side speaker,
the left-side speaker and the substrate are connected by a first wire,
the right-side speaker and the substrate are connected by a second wire, and
the first and second wire have elasticity.

3. The earphones according to claim 1, wherein
the substrate includes a left-side substrate and a right-side substrate,
the left-side speaker and the left-side substrate are connected by a first wire,
the right-side speaker and the right-side substrate are connected by a second wire,
the left-side substrate and the right-side substrate are connected by a third wire, and
the first wire and the second wire have elasticity.

4. The earphones according to claim 1, wherein the substrate is housed in the left-side speaker or the right-side speaker, and the left-side speaker and the right-side speaker are connected by a wire having elasticity.

5. The earphones according to claim 1, wherein
the wires have an elasticity of at least 10%, and the stress when the wires, which have been elongated by not less than 10%, self-contract to a length which is 110% the length at the time of no elongation is not greater than 2N.

6. The earphones according to claim 1, wherein there are at least three wiring lengths depending on the distance between a left-side end of the left-side speaker and a right-side end of the right-side speaker.

7. The earphones according to claim 1, wherein the substrate or the speakers include a mechanism that can adjust the wiring length.

8. The earphones according to claim 6, wherein the wiring length can be adjusted by winding the wires on the substrate or the speakers or by meanderingly arranging the wires.

9. The earphones according to claim 6, wherein the substrate is provided with at least six protruding parts through which the wires pass, the wiring length is adjusted depending on the number of protruding parts through which the wires pass, and the wires include a mechanism for attachment to the protruding parts.

10. The earphones according to claim 6, wherein the wiring length can be adjusted by changing the number of times the wires are wound around the left-side speaker and the right-side speaker, and the wires include a mechanism for attachment to clearances provided in both speakers.

11. The earphones according to claim 6, wherein when the earphones are worn on a head, the wiring length can be adjusted so that a pressure applied to the head by the substrate is 0.1 hpa to 30 hpa.

12. A method for equipping the earphones according to claim 1, wherein
when the earphones are worn on a head, a pressure applied to the head by the substrate is 0.1 hpa to 30 hpa.

13. A method for equipping the earphones according to claim 1, wherein the wires are attached in groove parts between the left and right ears and the head.

14. A method for equipping the earphones according to claim 1, wherein
there is no shaking of the substrate, components or wires, so that impact noise and fricatives are reduced in heard sounds.

15. A method for equipping the earphones according to claim 1, wherein
by attaching the substrate and components to the occipital region or top of the head with contraction force of the wires, even if a wearer moves or moves their head, the substrate and components do not move.

16. The earphones according to any one of claim 2, wherein
the wires have an elasticity of at least 10%, and the stress when the wires, which have been elongated by not less than 10%, self-contract to a length which is 110% the length at the time of no elongation is not greater than 2N.

17. The earphones according to any one of claim 3, wherein
the wires have an elasticity of at least 10%, and the stress when the wires, which have been elongated by not less than 10%, self-contract to a length which is 110% the length at the time of no elongation is not greater than 2N.

18. The earphones according to any one of claim 4, wherein
the wires have an elasticity of at least 10%, and the stress when the wires, which have been elongated by not less than 10%, self-contract to a length which is 110% the length at the time of no elongation is not greater than 2N.
